(19) United States
(12) Patent Application Publication
(10) Pub. No.: US 2020/0001999 A1
(43) Pub. Date: Jan. 2, 2020

(54) Air-Transportable Device For Projecting Pressurised Liquid

(71) Applicant: Antoni Abellan SALMERON, Barcelona (ES)

(72) Inventor: Antoni Abellan SALMERON, Barcelona (ES)

(21) Appl. No.: 16/488,433

(22) PCT Filed: Feb. 24, 2018
(86) PCT No.: PCT/ES2018/070142

§ 371 Date: Aug. 23, 2019

(30) Foreign Application Priority Data
Feb. 24, 2017 (ES) P201730243

(51) Int. Cl. B64D 1/18; B64C 39/02; B05B 13/00; G01M 5/00; B05B 12/12; A62C 3/02; H04N 5/28; B08B 3/02

(52) U.S. Cl. CPC B64D 1/18; B64C 39/02; B05B 13/005; G01M 5/0091; B05B 12/12; A62C 3/0235; H04N 5/247; B08B 3/024; B64C 2201/027; B64C 2201/12; B64C 2201/141; B64C 2201/024; H04N 5/28

(57) ABSTRACT

The invention relates to an air-transportable device (100) for projecting pressurized liquid over a surface, comprising a rotating washing head and an inspection system (11) with LED bulbs and cameras. The air-transportable device (100) is secured to an aircraft (200, 500) by the upper surface thereof or by means of straps and can be configured for different uses such as cleaning wind and photovoltaic facilities, extinguishing fires or cleaning insulators.

The present invention relates to an air-transportable device for projecting pressurized liquid, for cleaning wind and photovoltaic facilities, which can also be used for extinguishing fires, by projecting high-pressure liquid products from an aircraft, preferably from a vertical take-off and landing aircraft that can be manned or unmanned.

### PRIOR ART

The loss of production from wind turbines due to so-called aerodynamic profile breakdown is generally known in the prior art. This occurs when environmental dirt produced by dust, moisture, pollution, insect impacts, and a lack of rainfall during a certain period of time causes this profile breakdown and the weight built up on the surface of the blades causes production losses estimated to be between 5% and 25%. Likewise, it has been sufficiently proven that, after effective cleaning, production values return to their original level, as can be read in [Double Stall. C. Bak et al. Riso National Laboratory, Roskilde, June 1998, ISBN 87-550-2417-3] or in [Dust effect of the Performance of Wind Turbine Airfoils. N. Ren et al. Journal of Electromagnetic Analysis & Applications, 2009, 1: 102-107, June 2009].

Wind turbine blades are conventionally cleaned manually, with lifting cranes independent of the wind turbine structures or by means of a pulley lifting system via the rotor, in physical contact with mobile elements of the turbine. This system is slow, expensive, requires more labor and carries risks for personnel as well as for the wind turbine structure.

There is also an automatic method using pipes secured to the structure that emit a jet of water and detergents at a pressure of 50 bar for a considerable time while the blades rotate. This attempts to simulate the cleaning effects of rain. This method, however, does not cover all the angles of the blades with the same effectiveness, or the front face of the blades, which is precisely the one that needs the most clean surface area. A large amount of water is used and its implementation and costs are considerable.

Therefore, wind turbine maintenance is a well-accepted necessity among the operational costs, and it needs to be reduced in order to increase profitability, since the currently known methods are slow, expensive and entail a high risk for the personnel in charge of performing the cleaning operations, for example the system described in: http://www.pro-bel.ca/ProductsAndServices-BladeAccessEquipment.html.

Documents US2013133199 and ES2381351, which are based on modifying the actual blade, are also known, but are not practical for installed wind turbines.

On the other hand, helicopter cleaning is widely used in high-voltage insulators. Document WO2011042011 describes a pressurized-water cleaning system using helicopters that is especially suitable for high-voltage insulators. However, this helicopter cleaning method, like other known methods (FR2586194, IT1244559, GB2261772 or JPH0268297), is not directly applicable to the cleaning of wind turbine blades. For a start, the cleaning equipment varies, requiring an adaptation of the water-outlet pressures, an adaptation of the angle of attack, and a rotation of the outlet nozzle and the pole assembly in order to achieve profitable, safe execution times. In addition, it is important to remember that wind turbines are installed in areas of strong wind, unlike most high-voltage lines, which contributes significantly to the accuracy of cleaning and requires a solution of its own.

On the other hand, offshore wind fields are becoming increasingly common, and here it is impossible to use conventional cleaning systems (such as trucks with water cannons), so the use of air-transported cleaning systems becomes even more necessary.

In addition, the legal requirements that govern air-transported systems mean that any possibility of using one type of system in other applications is entirely ruled out. In other words, aeronautical regulations require systems to be validated for each application, so a person skilled in the art would rule out the direct application of the systems for cleaning insulators.

Systems for cleaning wind turbine blades are known in the prior art, at least from document DE102009048778, which describes a cleaning apparatus based on a multipurpose helicopter comprising a tank with a cleaning liquid, as well as a support frame that is attached to the helicopter by one side. The cleaning equipment also includes a mobile washing lance that allows the pressurized washing liquid to be directed against the blades of the wind turbine.

Document DE102010048400, on the other hand, describes a method which is used to check the structural condition of wind turbines. US2006237558, on the other hand, describes a spray device for use in aircraft such as helicopters. U.S. Pat. No. 4,477,289 also describes a system that can be air-transported by helicopter for cleaning the insulators in medium- and high-voltage lines.

As already mentioned, and in conclusion, aeronautical regulations for on-board systems are very strict (especially in the European Union “EASA” and the United States “FAA”, among others). In fact, all on-board systems require strict approval procedures (STC) for each different type of aircraft. Thus, in the case of the existing cleaning systems, if for example one of them is approved for a Bell-212 helicopter, it could never be directly removed and installed on another type of helicopter, even one from the same manufacturer (such as a Bell-222) without prior technical-legal approval that, where appropriate, may impose restrictions on use and designs that are impossible to undertake, both technically and economically. Even on the same helicopter model, but with European registration, it would not be valid in other countries such as the USA.

Therefore, faced with the systems described, a system that is not dependent on the type of aircraft used becomes necessary.

### DESCRIPTION OF THE INVENTION

The present invention relates to an air-transportable device for projecting pressurized liquid, according to the first claim that accompanies the present description. Specific embodiments of the invention are described in dependent claims.

This device makes it possible to separate the device from the aircraft used since, as it is transported externally, in the same way as a cargo basket, it does not need any type of approval, but simply to comply with the basket-specific specifications for each helicopter (i.e. essentially weight, centering, center of gravity, and dimensions) established by the aircraft manufacturer and/or operator. Thus, it is not treated like on-board system, but rather as an external load.

Another advantage over the prior art is that the device is operated remotely. In other words, unlike in the cited documents, the operator is inside the cabin of the aircraft or, if the aircraft is unmanned, at the actual ground control console.

The aim of the present invention is to wash wind turbine blades and structures. Windpower structures are currently cleaned using ropes or by lowering a basket along the mast, taking 1.5 days to complete the process of cleaning the structure, with the consequent loss of production and risk for workers. Compared with these systems, the present invention allows the same structure to be cleaned in approximately 10-20 minutes using biodegradable detergents. In addition, if de-icing operations are to be carried out, the device of the invention optionally has a heating unit with a pellet burner configured to heat the water to approximately 80° C., which is subsequently mixed with anti-freeze. In these cases, the productivity of the wind farm can be increased by 100% and the use of fossil fuels to cover periods of inactivity can be reduced.

Likewise, it simultaneously incorporates a gyro-stabilized filming system that allows thorough inspection of the structures by means of high-resolution video and thermographic equipment, thus doing away with the extra costs involved in having to hire another supplier to perform periodic inspection.

The present invention also relates to providing a device for washing and inspecting photovoltaic installations. Pollution, dust or saltpeter can all reduce the solar collection capacity of panels, thus causing performance losses. Photovoltaic panels need to be washed periodically, but in facilities that have a large number of panels, cleaning is a very slow, difficult and expensive task. However, thanks to the invention, as with wind farms, it is possible to reduce cleaning costs and exponentially increase the performance of the facilities. In addition, the visual, HD, and IR inspection of the panels is carried out simultaneously, thus avoiding the extra cost of hiring an inspection company.

Another aim of the present invention is the washing of insulators and simultaneous inspection of high-voltage lines. Current systems for cleaning insulators using existing helicopters (in practice, only two helicopter models) have a number of drawbacks: the distance of the cleaning water jet is 1.5 meters; they are only approved for two helicopter models; it is necessary to keep the helicopter door open so that the operator can use the cleaning device; the cleaning equipment is secured to the chassis of the helicopter, which makes it difficult to position the helicopter with respect to the wind; there is constant danger due to the proximity of the operation to the lines; current systems are unable to wash the central insulator in most high-voltage lines.

However, these problems are solved in the present invention, which also adds the possibility of using a biodegradable, dielectric detergent, as well as of simultaneously performing thermographic and high-definition visual inspection, avoiding having to hire two separate services.

Another aim of the present invention is to fight fires in urban and forested areas. Thanks to the present invention, a helicopter can enter urban areas to extinguish fires, reaching heights at which current ladders or cranes used by fire fighters are unable to operate. At the same time, the device of the invention records and broadcasts live images thanks to its gyro-stabilized filming system and thermographic camera that makes it possible, even through smoke, to distinguish the presence of people in a living space or to inform, while attacking the fire, on the hot spots in the area. In addition, in forested areas it allows directional projection of liquids or complete emptying of the tank.

In other words, compared with manned aircraft, the present invention overcomes the limitations of lack of visibility due to smoke, wind, and in particular nightfall, which forces these aircraft to retire. However, the present invention, particularly when it can be operated by remote control, can enter areas filled with smoke or with strong winds and operate at night without risk for people, being able to broadcast visual and thermographic images in real time via a single unit or with a swarm of units, both in urban and forested areas. Throughout the description and claims the word “comprises” and its variants do not intend to exclude other technical features, additives, components or steps. For a person skilled in the art, other subjects, advantages and characteristics of the invention will emerge partly from the description and partly from the practice of the invention. The following examples and drawings are provided by way of illustration, and are not intended to have a limiting effect on the present invention. In addition, the present invention covers all possible combinations of particular and preferred embodiments indicated herein.

### BRIEF DESCRIPTION OF THE FIGURES

Next, a series of drawings that help to better understand the invention and that expressly relate to an embodiment of said invention that is presented as a non-limiting example thereof is described very briefly.

FIG. 1 shows an exploded view of the cleaning device of the present invention.

FIG. 2 shows a view of the device of FIG. 1 transported by a helicopter.

FIG. 3 shows a schematic representation of the device of the invention, air-transported autonomously by an unmanned aerial vehicle or drone.

FIG. 4 shows a second schematic view of the device of FIG. 3.

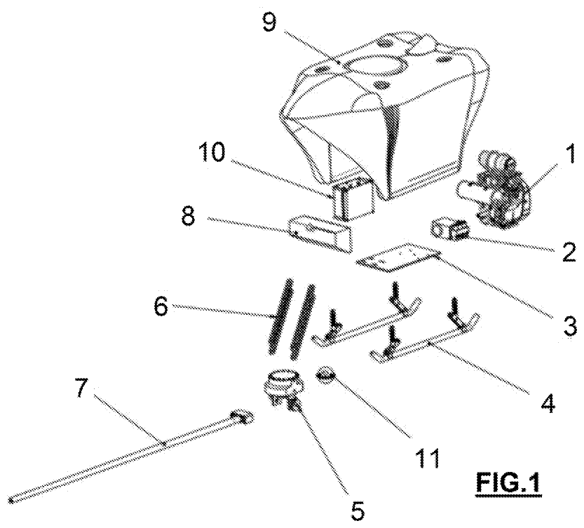

### DISCLOSURE OF A DETAILED EMBODIMENT OF THE INVENTION

As indicated below, the accompanying figures use the following numerical references that integrate the air-transportable device for projecting pressurized liquid (100) that is the subject of the present invention:

```
  1: combustion engine
  2: pressurized water pump
  3: chassis base
  4: cushioned skates
  5: rotating head
  6: folding arms
  7: lance or pole
  8: fuel tank
  9: water tank
  10: automaton
  11: gyro-stabilized device
100: air-transportable device
200: aircraft or helicopter
300: control console
400: fastening straps
500: unmanned aerial vehicle
```

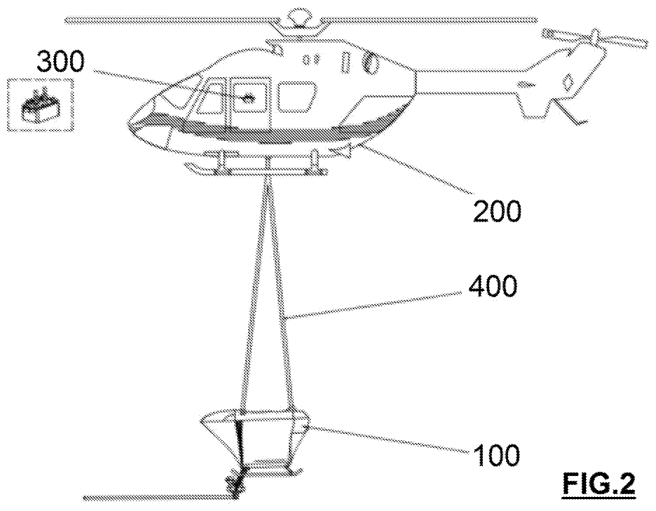

The water tank (9) is made of polyester fiber for hot water at a maximum temperature of 80° C. so that it can be used in de-icing tasks, if necessary. In addition, the water tank (9) comprises several bulkhead walls to maintain stability during its transport as a basket of the aircraft or helicopter (200), as best seen in FIG. 2. In addition, the water tank (9) comprises an internal structure of four aluminum struts for the assembly, providing rigidity to the entire structure, in addition to supporting two shock-absorbing skates (4) that allow the entire device (100) to be supported on the ground during both the take-off and the landing of the aircraft (200). Finally, the water tank (9) comprises, at the top, four anchor points for cables or winches, which are configured as the straps (400) for fastening the cleaning device (100) to the helicopter (200).

The water tank (9) is connected to a soap tank and additionally includes side doors for quick emptying of the tank (9) in case of emergency or for extinguishing forest fires. In addition, the water is loaded into the tank by means of an automatic suction pump with suction hose hanging under the equipment.

In a tunnel inside the water tank (9), the cleaning device (100) comprises a 20 to 40 HP combustion engine (1) in various embodiments, as well as a pressurized water pump (2) of the type with high-pressure pistons, for supplying 60 liters/minute of water at up to 250 bar pressure in a configuration for cleaning wind or photovoltaic facilities, or else a pump for up to 850 liters/minute of water at 20 bar in a configuration suitable for extinguishing fires. The combustion engine (1) is supplied from a fuel tank (8), while the pressurized water pump (2) is completed with its corresponding safety valves, pulley transmission, and timing belt.

The device (100) comprises two folding arms (6) actuated by a linear actuator to raise and lower a washing head (5, 7). The washing head is made up of a rotating head (5), which can rotate through 340° horizontally and 120° vertically, with rotary fittings for the passage of water to a lance or pole (7) having a length of 3 to 6 meters, with nozzles for pressure washing or simple water projection, depending on the purpose for which the device (100) is to be used.

The device (100) is completed with a gyro-stabilized inspection device (11) comprising a plurality of LED spotlights and a high-definition camera (FHD or 4K), as well as an infrared (IR) camera which, being aligned with the lance (7), is mounted on the rotating head (5), which allows it to be used for inspection in any condition.

One of the advantages of the present invention is its versatility of use, since the primary use of the device (100) can be changed with minimal changes, such as the power of the combustion engine (1) (preferably, 15-30 HP with electric starting for the fire-extinguishing model and, preferably, 20-40 HP with electric starting for the cleaning configuration) or the type of pressurized water pump (2) (preferably 850 liters for fire extinguishing and, preferably, piston pump delivering 30 to 80 liters at 250 bar for high-pressure cleaning).

The device (100) is operated by an operator from inside the helicopter or aircraft (200) via a control console (300) that communicates with the device (100) through the automaton (10). This automaton (10) is a PLC or, in general, any programmable electronic device configured to execute a program or programs stored in a memory, where said program or programs comprise instructions to execute: (a) the start and execution of the cleaning or extinguishing functions when a minimum altitude is reached; (b) generating an alarm on the console (300) when the aircraft (200) descends to a minimum altitude, placing the lance or pole (7) in the central position, raising the head, and stopping the engine (1).

In addition, the following tables show the inputs and outputs that preferably configure the input, output, and communication signals between the automaton (10) and the console (300) for the correct execution of the cleaning or fire-extinguishing functions:

TABLE I
Console (300) outputs to automaton (10)

| | |
|---|---|
| Joystick for rotating lance (7) | Soap valve ON/OFF button |
| Joystick for raising lance (7) | Water pressure or shut-off ON/OFF button |
| Joystick for camera | Button for raising and lowering the head |
| movement functions | |
| Engine (1) start-stop buttons | Two-position engine (1) throttle button |
| Video camera switch | Gyro-stabilized device (11) controls |
| LED light switch | Thermographic camera control |
| Output for pilot's external | 24 V power input |
| control screen | |

TABLE II
Console (300) inputs from automaton (10)

| | |
|---|---|
| Counter of flight hours | Counter of device (100) |
| | engine (1) hours |
| Landed position, with head (5) | Head (5) extended indicator |
| folded horizontally | |
| Head (5) retracted indicator alarm | Trigger indicator |
| according to altimeter | |
| Water shortage or level warning | Engine (1) RPM |
| Engine (1) start/stop | Distance to target |
| Distance from device (100) to ground | Range finder |
| Artificial horizon indicator | Soap tank level |
| of the device (100) | |
| Water tank (9) level | Position with respect to the |
| | longitudinal axis of the aircraft |
| Fuel tank (8) level | Water pressure regulator |
| Water pressure indicator | Water tank (9) temperature |
| Outside temperature | Water conductivity meter |
| RECORD/PAUSE camera control | GPS coordinates |
| Centering target | Compass |

The air-transportable device (100) as described allows quick access and immediate response to any incident. In addition, the air-transportable device (100) can be placed at a variable height by means of straps with lengths of 10, 25, 20, 25 or 30 meters. The device can be refilled with 1,000 liters/minute from a truck, a swimming pool, a river, a lake or any other water source.

In addition, the effective distance of the water jet is adjusted by a pressure gauge and a flowmeter, regulating the effective distance up to 50 meters from the nozzle.

The cost differences between another washing method and the air-transportable one are very considerable, making this invention the most advantageous method even in economic terms. The cost of cleaning is very similar in all methods, but the difference in production time is very considerable, while also performing a complete inspection of the structure.

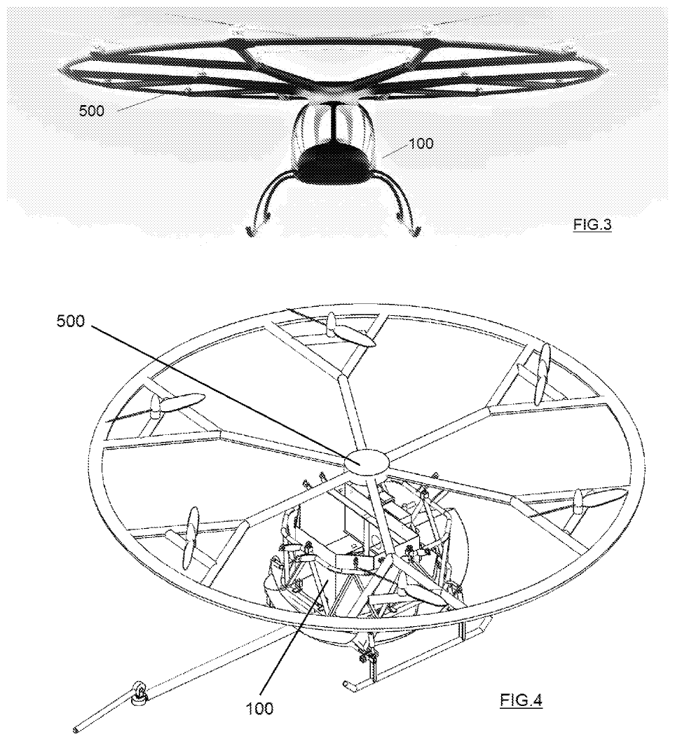

In a second embodiment of the invention, shown in FIGS. 3 and 4, the air-transportable device (100) is operated by an unmanned aerial vehicle such as a drone. For this, the air-transportable device (100) is secured to the bottom of a structure of an unmanned aerial vehicle (500) of the type configured for vertical take-off and landing. Thus, the unmanned aerial vehicle (500) comprises autonomous navigation means, ground control, and is configured for vertical take-off and landing, as well as for hovering.

Finally, we should highlight the differences between the use of unmanned aerial vehicles (500) and helicopters (200):

| Helicopter (200) | Unmanned aerial vehicle (500) |
|---|---|
| Average price for one hour of | Average price for one hour of flight: |
| flight: €2,800 | €12 |
| Effective hours per day: maximum | Effective hours per day: 20 |
| 6; 8 hours/day with a 20-minute | CO2 emissions per hour: 0; it is |
| break every hour | electric |
| CO2 emissions per hour: 390 kg | Liters of water projected/day: 40,000; |
| Liters of water projected/day: | 2,000 liters/hour × 20 hours |
| 24,000; 4,000 liters/hour × 6 hours | |

1. An air-transportable device (100) for projecting pressurized liquid over a surface, which comprises:
a liquid tank (9) comprising:
a plurality of internal bulkheads;
a plurality of internal struts;
cushioned skates (4) rigidly connected to the lower surface thereof; and
wherein an internal channel of the liquid tank (9) comprises a combustion engine (1) and a water pump (2);
which is characterized in that it also includes:
two folding arms (6) actuated by a linear actuator to raise and lower a washing head (5, 7); and a gyro-stabilized inspection device (11) comprising a plurality of LED bulbs, and at least one plurality of cameras, said gyro-stabilized inspection device (11) being mounted on said washing head (5, 7).

2. The device (100) according to claim 1, which is secured by the upper surface thereof to an aircraft (200, 500).

3. The device (100) according to claim 2, wherein the upper surface of the air-transportable device (100) is secured to the aircraft (200, 500) by means of a plurality of straps (400).

4. The device (100) according to claim 1, wherein the aircraft (500) is an unmanned aerial vehicle that comprises autonomous navigation means, ground control, and is configured for vertical take-off and landing, as well as for hovering.

5. The device (100) according to claim 1, wherein the washing head (5, 7) is made up of a rotating head (5) which can rotate through 340° horizontally and 120° vertically, with rotary fittings for the passage of water to a lance or pole (7) having a length of 3 to 6 meters, with nozzles for pressure washing or water projection.

6. The device (100) according to claim 1, wherein the gyro-stabilized inspection device (11) comprises at least one high-definition camera and at least one infrared camera.

7. The device (100) according to claim 1, wherein the liquid tank (9) comprises a plurality of side gates for quickly emptying the liquid tank (9).

8. An aircraft (200, 500) that includes an autonomous, air-transportable device for projecting pressurized liquid (100), characterized in that it comprises a control console (300) that communicates with the device (100) via an automaton (10); and wherein said automaton (10) is a programmable electronic device configured to execute a program or programs stored in a memory, wherein said program or programs comprise instructions to execute: (a) the start and execution of the cleaning or extinguishing functions when a minimum altitude is reached; (b) generating an alarm on the console (300) when the aircraft (200) descends to a minimum altitude, placing the lance or pole (7) in the central position, raising the rotary head (5), and stopping the engine (1).

9. The aircraft (200, 500) according to claim 8, comprising a plurality of straps (400) connected, like an external basket, to an autonomous, air-transportable device for projecting pressurized liquid (100).

10. The aircraft (200) of claim 9, which is a helicopter.

11. The aircraft (500) of claim 8, which is an unmanned aerial vehicle that comprises autonomous navigation means, ground control, and is configured for vertical take-off and landing, as well as for hovering.
